(19) United States
(12) Patent Application Publication
(10) Pub. No.: US 2006/0257028 A1
(43) Pub. Date: Nov. 16, 2006

(54) Method and device for detection of points of interest in a source digital image, corresponding computer program and data support

(75) Inventors: Christophe Laurent, Vignoc (FR); Nathalie Laurent, Vignoc (FR)

Correspondence Address: SHEWCHUK IP SERVICES, 533 77TH STREET WEST, EAGAN, MN, 55121, US

(73) Assignee: France Telecom, Paris (FR)

(21) Appl. No.: 10/541,118

(22) PCT Filed: Mar. 14, 2003
(86) PCT No.: PCT/FR03/00834

§ 371 Date: Jun. 23, 2006

(30) Foreign Application Priority Data
Dec. 31, 2002 (FR) 02/16929

(51) Int. Cl. G06K 9/46

(52) U.S. Cl. 382/191; 382/240

(57) ABSTRACT

The invention related to a method for detection of points of interest in a source digital image, by means of a wavelet transformation associating a sub-sampled image, called a scaled image, with a source image and wavelet coefficients corresponding to at least one detail image, for at least one level of decomposition, a point of interest being a point associated with a region of the image with high frequencies. The method comprises the following steps:—application of said wavelet transformation to said source image, generation of a single tree structure from the wavelet coefficients of each of said detail images and selection of at least one point of interest by analysis of said tree structure.

### 1. FIELD OF THE INVENTION

The field of the invention is that of the detection of points of interest, also called salient points, in a digital image. More specifically, the invention relates to a technique for the detection of points of interest implementing a wavelet-type approach.

A point of interest may be considered to be the representative of a spatial region of the image conveying a substantial portion of information.

Historically, the notion of the salient point has been proposed in the field of computer vision, where one of the major problems consists of the detection of the corners of the objects (whence the term “salient” used here below as a synonym for the term “of interest”). This term was subsequently broadened to include other characteristics of images such as contours, junctions etc.

In image processing, the detection of the salient points corresponding to the corners of the objects is of little interest. Indeed, the corners are generally isolated points, representing only a small part of the information contained in the image. Furthermore, their detection generates heaps of salient points in the textured or noisy regions.

Various other techniques have been proposed, relating especially to the salient points corresponding to the high frequency zones, namely to the contours of the objects. The invention can be applied more specifically to this type of technique.

A more detailed description is given here below of the different techniques for the detection of salient points.

### 2. PRIOR ART

The detection of salient points (also called points of interest) in images is a problem that has given rise to much research for many years. This section presents the main approaches classically used in the literature. Reference may be made to the document [5] (the documents referred to are listed together in the appendix B) for a more detailed review of the prior art.

One of the first methods was proposed by Harris and Stephens [7] for the detection of corners. Points of this type were deemed then to convey a major quantity of information and were applied in the field of computer vision.

To define this detector, the following quantity is defined at each point p(x,y) of the image I:
R_{x,y}=Det(M_{x,y})−kTr(M_{x,y})²
where M_{x,y} is a matrix defined by:

$${M}_{x , y} = G ( σ ) ⊗ [ \begin{matrix}{I}_{x}^{2} ( x , y ) & {I}_{x} ( x , y ) {I}_{y} ( x , y ) \\ {I}_{x} ( x , y ) {I}_{y} ( x , y ) & {I}_{y}^{2} ( x , y )\end{matrix} ]$$

where:
G(σ) denotes a Gaussian kernel with variance σ²;
\textcircled{x} denotes the convolution product;
Iₓ (resp. I_{y}) denotes the first derivative of I following the direction x (resp. y);
Det(M_{x,y}) denotes the determinant of the matrix M_{x,y};
Tr(M_{x,y}) denotes the trace of the matrix M_{x,y};
k is a constant generally used with a value of 0.04.

The salient points are then defined by the positive local extreme values of the quantity R_{x,y}.

In [5], the authors also propose a more precise version of the Harris and Stephens detector. This version replaces the computation of the derivatives of the image I by a precise computation of the Gaussian kernel.

The Harris and Stephens detector presented here above has been extended to the case of color pictures in [6]. To do this, the authors extend the definition of the matrix M_{x,y} which then becomes:

$${M}_{x , y} = G ( σ ) ⊗ [ \begin{matrix}( {R}_{x}^{2} + {G}_{x}^{2} + {B}_{x}^{2} ) ( x , y ) & ( {R}_{x} {R}_{y} + {G}_{x} {G}_{y} + {B}_{x} {B}_{y} ) ( x , y ) \\ ( {R}_{x} {R}_{y} + {G}_{x} {G}_{y} + {B}_{x} {B}_{y} ) ( x , y ) & ( {R}_{y}^{2} + {G}_{y}^{2} + {B}_{y}^{2} ) ( x , y )\end{matrix} ]$$

where:
Rₓ,Gₓ, Bₓ respectively denote the first derivatives of the red, green and blue colorimetrical planes in the direction x;
R_{y},G_{y},B_{y} respectively denote the first derivatives of the red, green and blue colorimetrical planes in the direction y;

In [10], the authors consider the salient points to be the points of the image showing high contrast. To build a detector of this kind, the authors use a multiple-resolution approach based on the construction of a Gaussian pyramid.

Let it be assumed that the image I has a size 2^{N}×2^{N}. We can define a pyramid with N levels where the level 0 corresponds to the original image and the level N-1 corresponds to a one-pixel image.

At the level k of the pyramid, the contrast of the point P is defined by:

$${C}_{k} ( P ) = \frac{{G}_{k} ( P )}{{B}_{k} ( P )} with 0 \leq k \leq N - 1 and {C}_{N} ( P ) = 1$$

where Gₖ(P) defines the local luminance at the point P and at the level k, and Bₖ(P) defines the luminance of the local background at the point P and at the level k.

These two variables are computed at each point and for each level of the pyramid. They can therefore be represented by two pyramids called a luminance pyramid and a background pyramid and defined by:

$${G}_{k} ( P ) = {\sum }_{M ∈ Fils ( P )}^{} w ( M ) {G}_{k - 1} ( M )$$

$${B}_{k} ( P ) = {\sum }_{Q ∈ Parent ( P )}^{} W ( Q ) {G}_{k + 1} ( Q )$$

where:
The notations Offspring (P) and Parent(P) denote the hierarchical relationships in the Gaussian pyramid;
w is a standardized weight function that can be adjusted in order to simulate the Gaussian pyramid;
W is a standardized weight function taking account of the way in which P is used to build a luminance of its ancestors in the pyramid.

In this approach, a salient point is a point characterized by a high value of the local contrast. In order to take account of the non-symmetry of the variable Cₖ, the authors introduce a new variable in order to obtain a zero value for a situation of non-contrast and a value >0 everywhere else.

This new variable is defined by:

$${C}_{k}^{*} ( P ) = Min ( \frac{\vert {G}_{k} ( P ) - {B}_{k} ( P ) \vert}{{B}_{k} ( P )} , \frac{\vert {G}_{k} ( P ) - {B}_{k} ( P ) \vert}{255 - {B}_{k} ( P )} ) .$$

With this new variable, the salient points are defined by the local maximum values of C*ₖ greater than a fixed threshold.

The salient points detector initially presented in [11] is doubtless the closest to the present invention since it is also based on the use of the theory of wavelets. Indeed, it is the view of the authors that the points conveying a major part of the information are localized in the regions of the image having high frequencies.

By using wavelets with compact carriers, the authors are capable of determining the set of points of the signal f (assumed for the time being to be one-dimensional) that were used to compute any wavelet coefficient whatsoever D₂_{^{j}}f(n), and can do so at any resolution whatsoever 2^{j} (j≦−1).

On the basis of this observation, the hierarchy of wavelet coefficients is built. For each resolution level and for each wavelet coefficient D₂_{^{j}}f(n) of this level, this hierarchy determines the set of wavelet coefficients of the immediately higher level of resolution 2^{j+1} necessary to compute D₂_{^{j}}f(n):
C(D₂_{^{j}}f(n))={D₂_{^{j+1}}f(k),2n≦k≦2n+2p−1},0≦n<2^{j}N
where p denotes the regularity of the wavelet base used (i.e. the size of the wavelet filter) and N denotes the length of the original signal f.

Thus, each wavelet coefficient D₂_{^{j}}f(n) is computed from 2^{-j}p points of the signal f Its offspring coefficients C(D₂_{^{j}}f(n)) give the variation of a subset of these 2^{-j}p points. The most salient subset is the one whose wavelet coefficient is the maximum (in absolute value) at the resolution level 2^{j+1}.

This coefficient therefore needs to be considered at this level of resolution. By applying this process recursively, a coefficient D₂_{^{−1}}f(n) is selected with the resolution ½. This coefficient represents 2p points of the signal f. To select the corresponding salient point in f, the authors propose to choose that point, among these 2p points, whose gradient is the maximum in terms of absolute value.

To extend this approach to the 2D signals constituted by the images, the authors apply the same approach to each of the three subbands D₂_{^{j}}¹I,D₂_{^{j}}²I,D₂_{^{j}}³I where I denotes the original image. In the case of the images, the spatial carrier of the wavelet base is sized 2p×2p. Thus, the cardinal of C(D₂_{^{j}}^{s}f(x,y)) is 4p² for any s=1,2,3. For each orientation (horizontal, vertical and oblique), the method makes a search, among the offspring coefficients of a given coefficient, for the one whose amplitude is the maximum. If different coefficients of different orientations lead to the same pixel of I, then this pixel is considered to be a salient point.

This technique has been used especially in image indexation in [9].

### 3. DRAWBACKS OF PRIOR ART

As shown in the previous section, many methods have been proposed in the literature for the detection of salient points.

The major difference between these approaches relies on the very definition of a salient point. Historically, researchers in the field of computer vision have devoted attention to the corners of objects. It is thus that the Harris and Stephens detector [7] was proposed. This detector has recently been extended to color in [6]. The corners of objects do not, however, represent any relevant information in the field of image processing. Indeed, in the case of weakly textured images, these dots will be scattered in space and will not give any satisfactory representation of the image. In the case of textured or noisy images, the dots will all be concentrated in the textures and within a local and non-comprehensive representation of the image.

The definition of contrast-based salience [10] is appreciably more interesting for image processing. Unfortunately, this approach suffers from the same defect as the previous one in the case of textured or noisy regions.
The wavelet-based approach proposed by E. Loupias and N. Sebe [11] is clearly the most robust and most worthwhile approach. Indeed, it has long been known that the contours represent the primary information of an image since it perfectly matches the human visual system.

### 4. GOALS AND CHARACTERISTICS OF THE INVENTION

It is therefore a particular aim of the invention to overcome the different drawbacks of the prior art.

More specifically, it is an aim of the invention to provide a technique for the detection of salient points corresponding to a high frequency, and giving preference to no particular direction in the image.

It is another aim of the invention to provide such a technique that calls for a reduced number of operations as compared with prior art techniques.

In particular, it is a goal of the invention to provide a technique of this kind enabling the use of wavelet bases with a large-sized carrier.

These goals, as well as others that shall appear more clearly here below, are achieved by means of a method for the detection of points of interest in a source digital image, said method implementing a wavelet transformation associating a sub-sampled image, called a scale image, with a source image, and wavelet coefficients corresponding to at least one detail image, for at least one level of decomposition, a point of interest being a point associated with a region of the image showing high frequencies.

According to the invention, this method comprises the following steps:
the application of said wavelet transformation to said source image;
the construction of a unique tree structure from the wavelet coefficients of each of said detail images;
the selection of at least one point of interest by analysis of said tree structure.

In the present document, for the sake of simplification, the term “source image” is applied to an original image or an image having undergone pre-processing (gradient computations, change of colorimetrical space etc.).

Advantageously, for each level of decomposition, at least two detail images, respectively corresponding to at least two directions predetermined by said wavelet transformation, are determined.

This wavelet transformation may use especially first-generation or second-generation (mesh-based) wavelets.

In particular, the detail images may comprise:
a detail image representing the vertical high frequencies;
a detail image representing the horizontal high frequencies;
a detail image representing the diagonal high frequencies.

Advantageously, the method of the invention comprises a step for merging the coefficients of said detail images so as not to give preference to any direction of said source image.

Advantageously, said step for the construction of a tree structure relies on a zerotree type of approach.

Thus, preferably, each point of the scale image having minimum resolution is the root of a tree with which is associated at least one offspring node respectively formed by each of the wavelet coefficients of each of said detail image or images localized at the same position, and then recursively, four offspring nodes are associated with each offspring node of a given level of resolution, these four associated offspring nodes being formed by the wavelet coefficients of the detail image that is of a same type and at the previous resolution level, associated with the corresponding region of the source image.

According to an advantageous aspect of the invention, said selection step implements a step for the construction of at least one salience map, assigning said wavelet coefficients a salience value representing its interest. Preferably, a salience map is built for each of said resolution levels.

Advantageously, for each of said salience maps, for each salience value, a merging is performed of the pieces of information associated with the three wavelet coefficients corresponding to the three detail images so as not to give preference to any direction in the image.

According to a preferred aspect of the invention, a salience value of a given wavelet coefficient having a given level of resolution takes account of the salience value or values of the descending-order wavelet coefficients in said tree structure of said given wavelet coefficient.

Preferably, a salience value is a linear relationship of the. associated wavelet coefficients.

In a particular embodiment of the invention, the salience value of a given wavelet coefficient is computed from the following equations:

$$\{ \begin{matrix}{S}_{{2}^{- 1}} ( x , y ) = {α}_{- 1} ( \frac{1}{3} {\sum }_{u = 1}^{3} \frac{{D}_{{2}^{- 1}}^{u} ( x , y )}{Max ( {D}_{{2}^{- 1}}^{u} )} ) \\ {S}_{{2}^{j}} ( x , y ) = \frac{1}{2} ( {α}_{j} ( \frac{1}{3} {\sum }_{u = 1}^{3} \frac{{D}_{{2}^{j}}^{u} ( x , y )}{Max ( {D}_{{2}^{j}}^{u} )} ) + \frac{1}{4} {\sum }_{u = 0}^{1} {\sum }_{v = 0}^{1} {S}_{{2}^{j + 1}} ( 2 x + u , 2 y + v ) )\end{matrix} \\$$

In these equations, the parameter Otk may for example have a value −1/r for all the values of k.

According to another preferred aspect of the invention, said selection step comprises a step for building a tree structure of said salience values, the step advantageously relying on a zerotree type approach.

In this case, said selection step advantageously comprises the steps of:
descending-order sorting of the salience values of the salience map corresponding to the minimum resolution;
selection of the branch having the highest salience value for each of the trees thus sorted out.

According to a preferred aspect of the invention, said step for the selection of the branch having the highest salience value implements a corresponding scan of the tree starting from its root and a selection, at each level of the tree, of the offspring node having the highest salience value.

As already mentioned, the invention enables the use of numerous wavelet transformations. One particular embodiment implements the Haar base.

One particular embodiment chooses a minimum level of resolution 2⁻⁴.

The method of the invention may furthermore include a step for the computation of an image signature, from a predetermined number of points of interest of said image.

Said signature may thus be used especially to index images by their content.

More generally, the invention can be applied in many fields, and for example for:
image watermarking;
image indexing;
the detection of faces in an image.

The invention also relates to devices for the detection of points of interest in a source digital image implementing the method as described here above.

The invention also relates to computer programs comprising program code instructions for the execution of the steps of the method for the detection of points of interest described here above, and the carriers of digital data that can be used by a computer carrying such a program.

Other characteristics and advantages of the invention shall appear from the following description of a preferred embodiment, given by way of a simple illustrative and non-exhaustive example and from the appended drawings, of which:

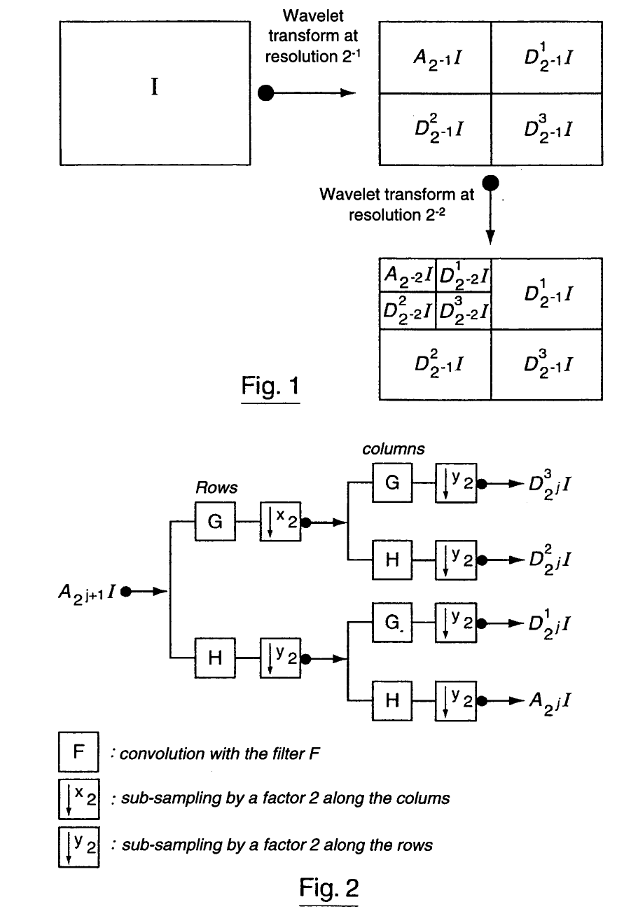

FIG. 1 illustrates the principle of multi-resolution analysis of an image I by wavelet transformation;

FIG. 2 presents a schematic view of a wavelet transformation;

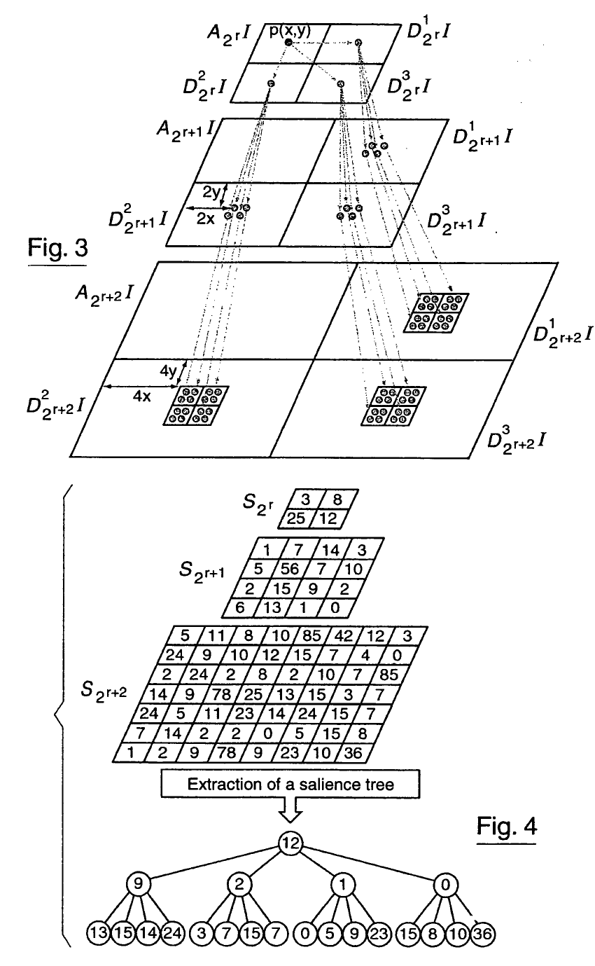

FIG. 3 provides a view of a tree structure of wavelet coefficients according to the invention;

FIG. 4 presents an example of salience maps and of the corresponding salience trees;

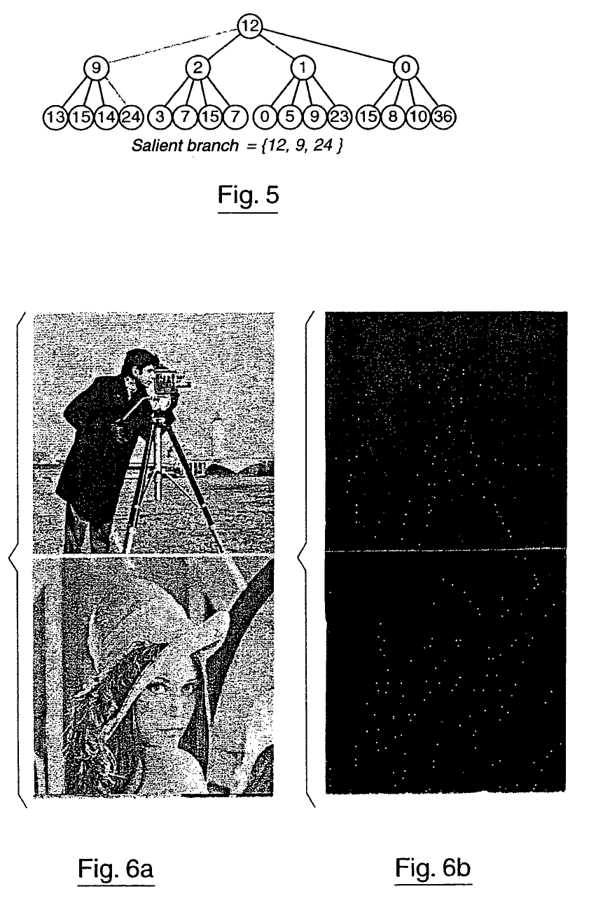

FIG. 5 illustrates the salience of a branch of the tree of FIG. 4;

FIGS. 6a and 6b illustrate experimental results of the method of the invention, FIG. 6a showing two original images and FIG. 6b showing the corresponding salient points;

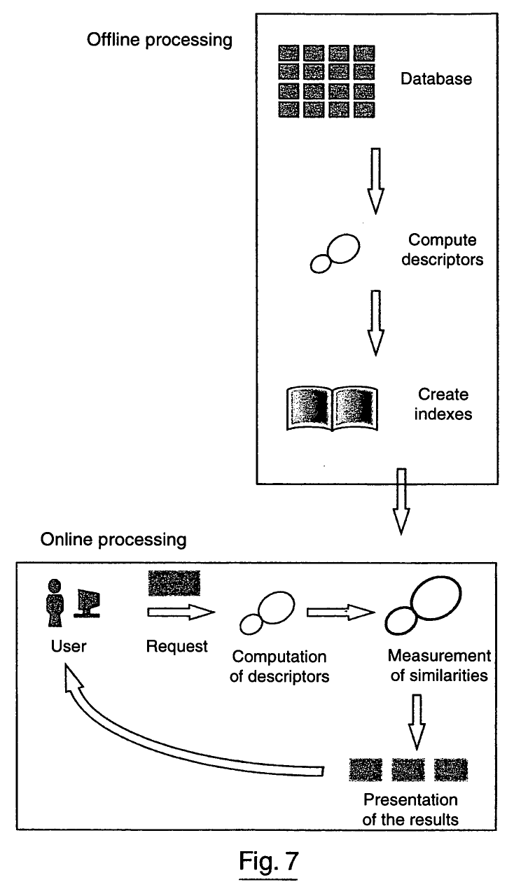

FIG. 7 illustrates an image indexing method implementing the detection method of the invention.

### 5. IDENTIFICATION OF THE ESSENTIAL TECHNICAL ELEMENTS OF THE INVENTION

5.0 General Principles

One aim of the invention therefore is the detection of the salient points of an image I. These points correspond to the pixels of I belonging to high-frequency regions. This detection is based on wavelet theory [1] [2] [3]. Appendix A briefly presents this theory.

Wavelet transform is a multi-resolution representation of the image enabling the image to be expressed at the different resolutions ½, ¼, etc. Thus, at each level of resolution 2^{j}(j≦−1), the wavelet transform represents the image I, sized n×m=2^{k}×2^{l}(k,l ∈ Z), in the form:
a coarse image A₂_{^{j}}I;
a detail image D₂_{^{j}}¹I represenfing the vertical high frequencies (i.e. the horizontal contours);
a detail image D₂_{^{j}}²I representing the horizontal high frequencies (i.e. the vertical contours);
a detail image D₂_{^{j}}³I representing the diagonal high frequencies (i.e. the corners).

Each of these images is sized 2^{k+j}×2^{l+j}. FIG. 1 illustrates this type of representation.

Each of these three images is obtained from A₂_{^{j+1}} I by a filtering followed by a sub-sampling by a factor of two as shown in FIG. 2. It must be noted that we have A₂_{⁰}I=I.

The invention therefore consists of choosing first of all a wavelet base and a minimum level of resolution 2^{r}(r≦−1). Once the wavelet transformation has been effected, it is proposed to scan each of the three detail images D₂_{^{r}}¹I, D₂_{^{r}}²I and D₂_{^{r}}³I in order to build a tree structure of wavelet coefficients. This tree structure is based on the zerotree approach [4], initially proposed for the image encoding. It enables the positioning of a salience map sized 2^{k+r}×2^{l+r} reflecting the importance of each wavelet coefficient at the resolution 2^{r}(r≦−1).

Thus a coefficient having significant salience corresponds to a region of I having high frequencies. Indeed, a wavelet coefficient having a high-value modulus at the resolution 2^{r}(r≦−1) corresponds to a contour of the image A₂_{^{r+l}}I along a particular direction (horizontal, vertical or oblique). The zerotree approach tells us that each of the wavelet coefficients at the resolution 2² corresponds to a spatial zone sized 2^{-r}×2^{-r} in the image I.

From the built-up salience map, the invention proposes a method for the choosing, from among of the 2^{-r}×2^{-r} pixels of I, of the pixel that most represents this zone.

In terms of potential applications, the detection of salient points in the images may be used non-exhaustively for the following operations:
Image watermarking: in this case, the salient points give information on the possible localization of the mark in order to ensure its robustness;
Image indexing: in detecting a fixed number of salient points, it possible to deduce a signature of the image from it (based for example on colorimetry around salient points) which may then be used for the computation of inter-image similarities;
Detection of faces: among the salient points corresponding to the high frequencies of the image, some are localized on the facial characteristics (eyes, nose, mouth) of the faces present in the image. They may then be used in a process of detection of faces in the images.

The technique of the invention differs from that proposed by E. Loupias and N. Sebe [11]. The main differences are:
The salient point search algorithm proposed by Loupias and Sebe requires a search among 2^{2j}×4p²×3 coefficients for each level of resolution 2^{j} and for a square image. Our algorithm is independent of the size of the wavelet base carrier, leading to a search from among 2^{2j}×4×3 coefficients. This advantage enables the use of the wavelet bases with a carrier that may be large-sized while most of the publications using the Loupias and Sebe detector use the Haar base which is far from being optimal.

The Loupias and Sebe method considers the subbands independently of each other thus leading them to the detection, by priority, of the maximum gradient points in every direction (i.e. the corners). For our part, we merge the information contained in the different subbands so that no preference is given to any particular direction.

5.1 Wavelet Tran Formation

Wavelet transformation is a powerful mathematical tool for the multi-resolution analysis of a function [1] [2] [3]. Appendix A provides a quick overview of this tool.

In the invention, the functions considered are digital images, i.e. discrete 2D functions. Without overlooking general aspects, we assume here that the processed images are sampled on a discrete grid of n lines and m columns with value range in a sampled luminance space containing 256 values. Furthermore it is assumed that n=2^{k}(k ∈ Z) and that m=2^{l} (l ∈ Z).

If the original image is referenced I, we then have:

$$I \text{:} \vert \begin{matrix}[ 0 , m ] \times [ 0 , n ] -> [ 0 , 255 ] \\ ( x , y ) aI ( x , y )\end{matrix} .$$

As mentioned in section 4, the wavelet transformation of I enables a multi-resolution representation of I. At each level of resolution 2^{j}(j≦−1), the representation of I is given by a coarse image A₂_{^{j}}I and by three detail images D₂_{^{j}}¹,I, D₂_{^{j}}²,I and D₂_{^{j}}³I. Each of these images is sized 2^{k+j}×2^{l+j}. This process is illustrated in FIG. 2.

Wavelet transformation necessitates the choice of a scale function Φ(x) as well as the choice of a wavelet function Ψ(x). From these two functions, a scale filter H and a wavelet filter G are derived, their respective pulse responses h and g being defined by:
h(n)=<φ₂_{^{−1}}(u), φ(u−n)>∀n ∈ Z
g(n)=<Ψ₂_{^{−1}}(u), φ(u−n)>∀n ∈ Z.

Let \tilde{H} and \tilde{G} respectively denote the mirror filters of H and G (i.e. \tilde{h}(n)=h(−n) and \tilde{g}(n)=g(−n)).

It can then be shown [1] (cf. FIG. 2) that:
A₂_{^{j}}I can be computed by convoluting A₂_{^{j+l}}I with \tilde{H}in both dimensions and by sub-sampling by a factor of two in both dimensions;
D₂_{^{j}}¹I can be computed by:
   1. convoluting A₂_{^{j+l}}I with \tilde{H} along the direction y and by sub-sampling by a factor of two along this same direction
   2. convoluting the result of the step 1) with \tilde{G} along the direction x and by sub-sampling by a factor of two along this same direction.
D₂_{^{j}}²I may be computed by:
1. convoluting A₂_{^{j+i}}I with \tilde{G} along the direction y and by sub-sampling by a factor of two along this same direction;
   2. convoluting the result of the step 1) with \tilde{H} and along the direction x and by sub-sampling by a factor of two along this same direction.
D₂_{^{j}}³I may be computed by:
   1. convoluting A₂_{^{j+l}}I avec \tilde{G} with \tilde{G} along the direction y and by sub-sampling by a factor of two along this same direction;
   2. convoluting the result of the step 1) with \tilde{G} along the direction x and by sub-sampling by a factor of two along this same direction.

5.2 Construction of the Tree Structure with Wavelet Coefficients

Once the wavelet transformation has been made up to the resolution 2^{r}(r≦−1), we have available:
an approximate image A₂_{^{r}}I;
Three detail images D₂_{^{j}}¹I, D₂_{^{j}}²I, D₂_{^{j}}³I per level of resolution 2^{j} with j=−1, . . . , r.

A tree structure of wavelet coefficients is then built by the zerotree technique [4]. The trees are built as follows (cf.figure 3):
Each pixel p(x,y) of the image A₂_{^{r}}I is the root of a tree;
Each root p(x,y) is assigned three offspring nodes designated by the wavelet coefficients of the three detail images D₂_{^{r}}^{s}I (s=1,2,3) localized at the same place (x,y);
Owing to the sub-sampling by a factor of two performed by the wavelet transformation at each change in resolution, each wavelet coefficient α₂_{^{r}}^{s}(x,y) (s=1,2,3) corresponds to a zone sized 2×2 pixels in the detail image corresponding to the resolution 2^{r+1}. This zone is localized at (2x,2y) and all the wavelet coefficients belonging to it become the offspring nodes of α₂_{^{r}}^{s}(x,y).

Recursively, the tree structure is constructed wherein each wavelet coefficient α₂_{^{u}}^{s}(x,y) (s=1,2,3 and 0>u>r) possesses four offspring nodes designated by wavelet coefficients of the image D₂_{^{u+1}}^{s}I localized in the region situated in (2x,2y) and sized 2×2 pixels.

Once the tree structure is constructed, each wavelet coefficient α₂_{^{r}}^{s} (x,y)(s=1,2,3) corresponds to a region sized 2^{-r}×2^{-r} pixels in the detail image D₂_{^{−1}}^{s}I.

5.3 Construction of the Salience Maps

Starting from the tree structure obtained by the preceding step, we propose to build a set of −r salience maps (i.e. one salience map per level of resolution). Each salience map S₂_{^{j}}(j=−1, . . . , r) reflects the importance of the wavelet coefficients present at the corresponding resolution 2^{j}. Thus, the more a wavelet coefficient will be deemed to be important with respect to the information that it conveys, the greater will be its salience value.

It must be noted that each wavelet coefficient gives preference to one direction (horizontal, vertical or oblique) depending on the detail image to which it belongs. However, we have chosen to favor no particular direction and have therefore merged the information contained in the three wavelet coefficients α₂_{^{j}}¹(x,y), α₂_{^{j}}²(x,y), α₂_{^{j}}³₁(x,y) whatever the level of resolution 2^{j} and whatever the localization (x,y) with 0≦x<2^{k+j} and 0≦y<2^{l+j}. Each salience map S₂_{^{j}} is sized 2^{k+j}×2^{l+j}.

Furthermore, the salience of each coefficient with the resolution 2^{j} must take account of the salience of its offspring in the tree structure of the coefficients.

In order to take account of all these properties, the salience of a coefficient localized at (x,y) with the resolution 2^{j} is given by the following recursive relationship:

$$\begin{matrix}Equation 1 \text{:} expression of the salience of a coefficient & \\ \{ \begin{matrix}{S}_{{2}^{- 1}} ( x , y ) = {α}_{- 1} ( \frac{1}{3} {\sum }_{u = 1}^{3} \frac{{D}_{{2}^{- 1}}^{u} ( x , y )}{Max ( {D}_{{2}^{- 1}}^{u} )} ) \\ {S}_{{2}^{j}} ( x , y ) = \frac{1}{2} ( {α}_{j} ( \frac{1}{3} {\sum }_{u = 1}^{3} \frac{{D}_{{2}^{j}}^{u} ( x , y )}{Max ( {D}_{{2}^{j}}^{u} )} ) + \frac{1}{4} {\sum }_{u = 0}^{1} {\sum }_{v = 0}^{1} {S}_{{2}^{j + 1}} ( 2 x + u , 2 y + v ) )\end{matrix} & \end{matrix}$$

Where:
Max(D₂_{^{j}}^{s}) (s=1,2,3) denotes the maximum value of the wavelet coefficients in the detail image D₂_{^{j}}^{s}I;
αₖ (0≦αₖ≦1)) is used to set the size of the salience coefficients according to the resolution level. It must be noted that we have

$${\sum }_{ k}^{} {α}_{k} = 1.$$
It must be noted that the salience values are standardized i.e. 0≦S₂_{^{j}}(x,y)≦1.

As can be seen in the Equation 1, the salience of a coefficient is a linear relationship of the wavelet coefficients. Indeed, as mentioned in section 4, we consider the salient points to be pixels of the image belonging to high-frequency regions. Now, a high wavelet coefficient α₂_{^{j}}^{s}(x,y)(s=1,2,3) at the resolution 2^{j} denotes a high-frequency zone in the image A₂_{^{j+l}}I with the localization (2x, 2y). Indeed, the detail images are obtained by a high-pass filtering of the image A₂_{^{j+l}}I , each contour of A₂_{^{j+l}}I generates an elevated wavelet coefficient in one of the detail images with the resolution 2^{j}, this coefficient corresponding to the orientation of the contour.

Thus, the formulation of the salience of a given image in the Equation 1 is warranted.

5.4 Choice of the Salient Points

Once the construction of the salience maps is completed, we propose a method in order to choose the most salient points in the original image.

To do this, we build a tree structure of the salience values from the −r built-up salience maps. In a manner similar to the building of the tree structure of the wavelet coefficients, we can build 2^{k+l+2r} trees of salience coefficients, each having a coefficient of S₂_{^{r}} as its root. As in the case of the zerotree technique, each of these coefficients corresponds to a zone sized 2×2 coefficients in the card S₂_{^{r+1}}. It is then possible to recursively construct the tree in which each node is assigned four offspring in the salience map having immediately higher resolution. FIG. 4 illustrates this construction.

In order to localize the most salient points in I, we carry out:
1. A descending-order sorting of the 2^{k+l+2r} salience values present in S₂_{^{r}};
2. Te selection of the maximum salience branch of each of the 2^{k+l+2r} trees thus sorted out.

In order to select this branch, it is proposed to scan the tree from the root. During this scan a selection is made, at each level of the tree, of the offspring node having the greatest salience value (cf. FIG. 5). We thus obtain a list of −r salience values:
SalientBranch={s2r(x1,y1),s2r+1(x2,y2), . . . , s2−1(x−r,y−r)}
with
(xₖ,yₖ)=Arg Max{s₂_{^{r+(k−2)}}(2xₖ₋₁+u,2yₖ₋₁+v),0≦u≦1,0≦v≦1}

From the most salient branches of each tree, the pixel of I chosen as being the most representative pixel of the branch is localized at (2x₋₁, 2y₋ᵣ). In practice, only a subset of the 2k+1+2r trees is scanned. Indeed, for many applications, a search is made for a fixed number n of salient points. In this case, it is appropriate to scan only the n trees having the most salient roots.

### 6. DETAILED DESCRIPTION OF AT LEAST ONE PARTICULAR EMBODIMENT

In this section, we use the technical elements presented in the previous section for which we set the necessary parameters in order to describe a particular embodiment.

6.1 Choice of Wavelet Transformation

As mentioned in section 5.1, we must first of all choose a wavelet base and a minimum resolution level 2^{r} (r≦−1).

For this particular embodiment, we propose to use the Haar base and r=−4.

The Haar base is defined by:

$$ϕ ( x ) \{ \begin{matrix}1 if 0 \leq x \leq 1 \\ else 0\end{matrix}$$

for the scale function, and by:

$$ψ ( x ) = \{ \begin{matrix}1 if 0 \leq x < \frac{1}{2} \\ - 1 if \frac{1}{2} \leq x < 1 \\ else 0\end{matrix}$$

for the wavelet function.

6.2 Construction of the Tree Structure of the Wavelet Coefficients

In this step, no parameter whatsoever is required. The process is therefore compliant with what is described in section 5.1.

6.3 Construction of the Salience Maps

In this step, we must choose the parameters αₖ (−1≧k≧r) used to adjust the importance given to the salience coefficients according to the level of resolution to which they belong.

In this particular embodiment, we propose to use

$${α}_{k} = \frac{- 1}{r} ∀ k ∈ [ r , - 1 ] .$$

6.4 Choice of the Salient Points

This step requires no parameter. The process is therefore compliant with what is described in section 5.4.

6.5 Experimental Results

The results obtained on natural images by using the parameters proposed in this particular embodiment are illustrated in FIG. 6.

6.6 Example of Application

Among the potential applications listed in the section 4, this section presents the use of salient points for the indexing of images fixed by the content.

6.6.1 Purpose of Image Indexing

Image indexing by content enables the retrieval, from an image database, of a set of images visually similar to a given image called a request image. To do this, visual characteristics (also called descriptors) are extracted from the images and form the signature of the image.

The signatures of the images belonging to the database are computed off-line and are stored in the database. When the user frequently submits a request image to the indexing engine, the engine computes the signature of the request image and cross-checks this signature with the pre-computed signatures of the database.

This cross-checking is made by computing the distance between the signature of the request image and the signatures of the database. The images most similar to the request image are then those whose signature minimizes the computed distance. FIG. 7 illustrates this method.

The difficulty of image indexing then lies entirely in determining descriptors and robust distances.

6.6.2 Descriptors Based on the Salient Points of an Image

In this section, we propose to compute the signature of an image from a fixed number of salient points. This approach draws inspiration from [9].

A colorimetrical descriptor and texture descriptor are extracted at the vicinity of each of the salient points. The colorimetrical descriptor is constituted by the 0 order (mean), 1^{st} order (variance) and 2^{nd} order moments in a neighborhood sized 3×3 around each salient point. The texture descriptor is constituted by the Gabor moments in a neighborhood sized 9×9.

Once the signature of the request image R has been computed, the distance D(R,Iⱼ) between this signature and the signature of the j^{th} image Iⱼ in the database is defined by:

$$D ( R , {I}_{j} ) = {\sum }_{i}^{} {W}_{i} {S}_{j} ( {f}_{i} ) , j = 1 , … , N$$

where N denotes the number of images in the database and Sⱼ(fᵢ) is defined by:
Sⱼ(fᵢ)=(xᵢ−qᵢ)^{T}(xᵢ−qᵢ)
where xᵢ and qᵢ respectively designate the i^{th} descriptor (for example i=1 for the colorimetrical descriptor and i=2 for the texture descriptor) of the j^{th} image of the base and of the request R. The weights Wᵢ make it possible to modulate the importance of the descriptors relative to each other.

### APPENDIX A: AN OVERVIEW OF THE THEORY OF WAVELETS

A.1 Introduction

Wavelet theory [1] [2] [3] enables the approximation of a function (a curve, surface, etc.) at different resolution levels. Thus, this theory enables a function to be described in the form of a coarse approximation and of a series of details enabling the perfect reconstruction of the original function.

Such a multi-resolution representation [1] of a function therefore enables the hierarchical interpretation of the information contained in the function. To do this, the information is reorganized into a set of details appearing at different resolution levels. Starting from a sequence of resolution levels in ascending order (rⱼ )_{j∈Z}, the details of a function at the resolution level rⱼ are defined as the difference of information between its approximation at the resolution rⱼ and its approximation at the resolution rⱼ₊₁.

A.2 Notation

Before presenting the bases of multi-resolution analysis in greater detail, in this section we shall present the notation that will be used in the document.
The sets of integers and real numbers are respectively referenced Z and R.
L²(R) denotes the vector space of the measurable and integrable 1D functions ƒ(x).
For ƒ(x) ∈ L²(R) and g(x) ∈ L²(R), the scalar product of ƒ(x) and g(x) is defined by:
   <ƒ(x), g(x)>=∫_{∞}^{∞}ƒ(u)g(u

)du.
For ƒ(x) ∈ L²(R) et g(x) ∈ L²(R), the convolution of ƒ(x) and g(x) is defined by:
   ƒ*g(x)=∫_{∞}^{∞}ƒ(u)g(x−u)du.
L²(R²) denotes the vector space of the functions ƒ(x,y) of two measurable and integrable variables.
For ƒ(x,y) ∈ L²(R²) and g(x,y) ∈ L²(R²), the scalar product of ƒ(x,y) and g(x,y) is defined by:
   <ƒ(x,y), g(x,y)>=∫_{∞}^{∞} ∫_{∞}^{∞}ƒ(u,v)g(u,v)dudv.

A.2 Properties of Multi-Resolution Analysis

This section intuitively presents the desired properties of the operator enabling the multi-resolution analysis of a function. These properties come from [1].

Let A₂_{^{j}} be the operator that approximates a function ƒ(x) ∈ L²(R) with the resolution 2^{j}(j≧0) (i.e. ƒ(x) is defined by 2^{j} samples).

The following are the properties expected from A₂_{^{j}}:

1. A₂_{^{j}} is a linear operator. If A₂_{^{j}}ƒ(x) represents the approximation of ƒ(x) with the resolution 2¹, then A₂_{^{j}}ƒ(x) should not be modified when it is again approximated at the resolution 2^{j}. This principle is written as A₂_{^{j}}∘A₂_{^{j}}=A₂_{^{j}} and shows that the operator A₂_{^{j}} is a projection vector in a vector space V₂_{^{j}}⊂L²(R). This vector space may be interpreted as the set of all the possible approximations at the resolution 2^{j} of the functions of L²(R).

2. Among all the possible approximations of ƒ(x) with the resolution 2^{j}, A₂_{^{j}}ƒ(x) is the most similar to ƒ(x). The operator A₂_{^{j}} is therefore an orthogonal projection on V₂_{^{j}}.

3. The approximation of a function at the resolution 2^{j+l} contains all the information necessary to compute the same function at the lower resolution 2^{j}. This property of causality induces the following relationship:
∀j ∈ Z, V₂_{^{j}}⊂ V₂_{^{j+1}}.

4. The operation of approximation is the same at all values of resolution. The spaces of the approximation function may be derived from one another by a change of scale corresponding to the difference of resolution.
∀j ∈ Z,ƒ(x) ∈ V₂_{^{j}} [symbol] ƒ(2x) ∈ V₂_{^{j+l}}.

5. When an approximation of ƒ(x) at the resolution 2^{j}, is computed, a part of the information contained in ƒ(x) is lost. However, when the resolution tends toward infinity, the approximate function must converge on the original function ƒ(x). In the same way, when the resolution tends toward zero, the approximate function contains less information and must converge on zero.

Any vector space (V₂_{^{j}})^{j∈Z} that complies with all these properties is called the multi-resolution approximation de L² (R).

A.3 Multi-Resolution Analysis of a ID Function

A.3.1 Search for a Base of V₂,

We have seen in section A.2 that the approximation operator A₂_{^{j}} is an orthogonal projection in the vector space V₂_{^{j}}. In order to numerically characterize this operator, we must find an orthonormal base of V₂_{^{j}}.

V₂_{^{j}}, being a vector space containing the approximations of functions of L²(R) with the resolution 2^{j}, any function ƒ(x) ∈ V₂_{^{j}} may be seen as a vector with 2^{j} components. We must therefore find 2^{j} base functions.

One of the main theorems of the theory of wavelets stipulates that there is a single function Φ(x) ∈ L²(R), called a scale function, from which it is possible to define 2^{j} base functions Φᵢ^{j}(x) de V₂_{^{j}} by expansion and translation of Φ(x):
Φᵢ^{j}(x)=Φ(2^{j}x−i), i=0, . . . , 2^{j}−1.

Approximating a function ƒ(x) ∈ L²(R) at the resolution 2^{j} therefore amounts to making an orthogonal projection ƒ(x) on the 2^{j} basic functions Φᵢ^{j}(x). This operation consists in computing the scalar product of ƒ(x) with each of the 2^{j} basic functions Φᵢ^{j}(x):

$$\begin{matrix}{A}_{{2}^{j}} f ( x ) = {\sum }_{k = 0}^{k = {2}^{j} - 1} 〈 f ( u ) , {Φ}_{k}^{j} ( u ) 〉 {Φ}_{k}^{j} ( x ) \\ = {\sum }_{k = 0}^{k = {2}^{j} - 1} 〈 f ( u ) , Φ ( {2}^{j} u - k ) 〉 Φ ( {2}^{j} u - k ) . \\ \end{matrix}$$

It can be shown [1] that A₂_{^{j}}ƒ(x) may be reduced to the convolution of ƒ(x) with the low-pass filter Φ(x), assessed at the point k:
A₂_{^{j}}ƒ=(ƒ(u)* Φ(−2^{j}u))(k),k ∈ Z.

Since Φ(x) is a low-pass filter, A₂_{^{j}}ƒ may be interpreted as a low-pass filtering followed by a uniform sub-sampling.

A.3.2 Construction of the Multi-Resolution Analysis

In practice, the functions ƒ to be approximated (signal, image, etc.) are discrete. Let it be assumed that the original function ƒ(x) is defined on n=2^{k}(k ∈ Z) samples. The maximum resolution of ƒ(x) is then n.

Let Aₙƒ be the discrete approximation of ƒ(x) at the resolution level n. According to the property of causality, it is claimed (cf. section A.2) that A₂_{^{j}}ƒ can be computed from An,f for every value of j<k.

Indeed, in computing the projection of the 2^{j} basic functions Φᵢ^{j} (x) of V₂_{^{j}} on V₂_{^{j+1}}, it can be shown that A₂_{^{j}}ƒ can be obtained by convoluting A₂_{^{j+l}}ƒ with the low-pass filter corresponding to the scale function and by sub-sampling the result by a factor of 2:

$${A}_{{2}^{j}} f ( u ) = {\sum }_{k = 0}^{{2}^{j + 1} - 1} h ( k - 2 u ) {A}_{{2}^{j + 1}} f ( k ) , 0 \leq u < {2}^{j} - 1$$

$$with h ( n ) = 〈 Φ ( 2 u ) , Φ ( u - n ) 〉 , ∀ n ∈ Z .$$

A.3.3 The Detail Function

As mentioned in the property (5) of section A.3, the operation which consists in approximating a function ƒ(x) at the resolution 2^{j} on the basis of an approximation at the resolution 2^{j+l} causes a loss of information.

This loss of information is contained in a function called a detail function at resolution level 2^{j} and referenced D₂_{^{j}}ƒ. It must be noted that knowledge of D₂_{^{j}}ƒ and A₂_{^{j}}ƒ enables the perfect reconstruction of the approximate function A₂_{^{j+1}}ƒ.

The detail function at the resolution level 2^{j} is obtained by projecting the original function ƒ(x) orthogonally on the orthogonal complement of V₂_{^{j}} in V₂_{^{j−1}}. Let W₂_{^{j}} be this vector space.

To calculate this projection numerically, we need to find an orthonormal base of W₂_{^{j}} i.e. 2^{j} base functions. Another important theorem of the wavelet theory stipulates that, through a scale function Φ(x), it is possible to define 2^{j} base functions of W₂_{^{j}}. These base functions Ψᵢ^{j}(x) are obtained by expansion and translation of a function Ψ(x) called a wavelet function:
Ψᵢ^{j}(x)=Ψ(2^{j}x−i), i=0, . . . , 2^{j}−1.

In the same way as for the construction of the approximation A₂_{^{j}}ƒ, it can be shown that D₂_{^{j}}ƒ can be obtained by a convolution of the original function ƒ(x) with the high-pass filter Ψ(x) followed by a sub-sampling by a factor of 2^{j}
D₂_{^{j}}ƒ=(ƒ(u)*Ψ(−2^{j}u))(k),k ∈ Z.

A.4.5 Extension to the Multi-Resolution Analysis of 2D Functions

This section presents the manner of extending multi-resolution analysis by wavelets to the functions of L² (R²) such as images.

This is done by using the same theorems as the ones used earlier. Thus if V₂_{^{j}} denotes the vector space of the approximations of L²(R²) at the resolution 2^{j}, it can be shown that it is possible to find an orthonormal base of V₂, by expanding and translating a scale function Φ(x,y) ∈ L²(R²):
Φᵢ^{j}(x,y)=Φ(2^{j}x−i,2^{j}y−j), (i,j) ∈ Z².

In the particular case of the separable approximations of L²(R²), we have Φ(x,y)=Φ(x)Φ(y) where Φ(x) is a scale function of L²(R). In this case, the multi-resolution analysis of a function of L²(R²) is done by the sequential and separable processing of each of the dimensions x and y.

As in the 1D case, the detail function at the resolution 2^{j} is obtained by an orthogonal projection of ƒ(x,y) on the complement of V₂_{^{j}}, in V₂_{^{j+1}}, written as W₂_{^{j}}. In the 2D case, it can be shown that if Ψ(x) denotes the wavelet function associated with the scale function Φ(x), then the three functions defined by:
Ψ¹(x,y)=Φ(x)Ψ(y)
Ψ²(x,y)=Ψ(x)Φ(y)
Ψ³(x,y)=Ψ(x)Ψ(y)

are wavelet functions of L² (R² ). Expanding and translating these three wavelet functions gives an orthonormal base of W₂_{^{j}}:
Ψⱼ¹(x,y)=ΦΨ(2^{j}x−k,2^{j}y−l)
Ψ²(x,y)=ΨΦ(2^{j}x−k,2^{j}y−l)
Ψ³(x,y)=ΨΨ(2^{j}x−k,2^{j}y−l).

The projection of f(x,y) on these three base functions of the base of W₂_{^{j}} gives three detail functions:
D₂_{^{j}}¹ƒ=ƒ(x,y)*Φ^{j}(−x)Ψⱼ(−y)
D₂_{^{j}}²ƒ=ƒ(x,y)*Ψ^{j}(−x)Φⱼ(−y)
D₂_{^{j}}¹ƒ=ƒ(x,y)*Ψ^{j}(−x)Ψⱼ(−y)

### APPENDIX B: REFERENCES

[1] Mallat S., “A Theory for Multiresolution Signal Decomposition: the Wavelet Representation”, IEEE Transactions on Pattern Analysis and Machine Intelligence, Vol. 11, No. 7, July 1989, pp. 674-693.
[2] Stollnitz E. J., DeRose T. D., Salesin D., “Wavelets for Computer Graphics: A Primer-Part 1”, IEEE Computer Graphics and Applications, Mai 1995, pp. 76-84.
[3] Stollnitz E. J., DeRose T. D., Salesin D., “Waveletsfor Computer Graphics: A Primer-Part 2”, IEEE Computer Graphics and Applications, July 1995, pp. 75-85.
[4] Shapiro J. M., “Embedded Image Coding Using zerotrees of Wavelet Coefficients”, IEEE Transactions on Signal Processing, Vol. 41, No. 12, December 1993, pp. 3445-3462.
[5] Schmid C., Mohr R. and Bauckhage C., “Evaluation of Interest Point Detectors”, International Journal of Computer Vision, Vol. 37, No 2, pp. 151-172, 2000.
[6] Gouet V. and Boujemaa N., “About Optimal Use of Color Points of Interest for Content-Based Image Retrieval”, INRIA research report, No 4439, April 2002.
[7] Harris C. and Stephens M., “A Combined Corner and Edge Detector”, Proceedings of the 4^{th} Alvey Vision Conference, 1988.
[9] Sebe N. and Lew M. S., “Salient Points for Content-based Retrieval”, Proceedings of British Machine Vision Conference, Manchester, 2001.
[10] Bres S. and Jolion J. M., “Detection of Interest Points for Image Indexation”.
[11] Loupias E. and Sebe N., “Wavelet-based Salient Points for Image Retrieval”, Research Report RR 99.11, INSA Lyon, 1999.

1. A method for the detection of points of interest in a source digital image, said method implementing a wavelet transformation associating a sub-sampled image, called a scale image, with a source image, and wavelet coefficients corresponding to at least one detail image, for at least one level of decomposition,
a point of interest being a point associated with a region of the image showing high frequencies, wherein the method comprises the following steps:
the application of said wavelet transformations to said source image, during which for each decomposition level, there are determined at least two detail images corresponding respectively to at least two directions predetermined by said wavelet transformation
the merging of the coefficients of said detail images so as not to give preference to any direction of said source image; and
the construction of a unique tree structure from the wavelet coefficients of each of said detail images; and
the selection of at least one point of interest by analysis of said tree structure.

2. (canceled)

3. A method according to claim 1, wherein the detail images comprise:
a detail image representing the vertical high frequencies;
a detail image representing the horizontal high frequencies; and
a detail image representing the diagonal high frequencies.

4. (canceled)

5. A method according to claim 1, wherein said step for the construction of a tree structure relies on a zerotree type of approach.

6. A method according to claim 1, wherein each point of the scale image having minimum resolution is the root of a tree with which is associated an offspring node respectively formed with each of the wavelet coefficients of each of said detail image or images localized at the same position,
and then recursively, four offspring nodes are associated with each offspring node of a given level of resolution, these four associated offspring nodes being formed by the wavelet coefficients of the detail image that is of a same type and at the previous resolution level, associated with the corresponding region of the source image.

7. A method according to claim 1, wherein said selection step implements a step for the construction of at least one salience map, assigning said wavelet coefficients a salience value representing its interest.

8. A method according to claim 7, wherein a salience map is built for each of said resolution levels.

9. A method according to claim 7, wherein, for each of said salience maps, for each salience value, a merging is performed of the pieces of information associated with the three wavelet coefficients corresponding to the three detail images so as not to give preference to any direction in the image.

10. A method according to claim 7, wherein a salience value of a given wavelet coefficient having a given level of resolution takes account of the salience value or values of the descending-order wavelet coefficients in said tree structure of said given wavelet coefficient.

11. A method according to claim 7, wherein a salience value is a linear relationship of the associated wavelet coefficients.

12. A method according to claim 11, wherein the salience value of a given wavelet coefficient is computed from the following equations:
$$\{ \begin{matrix}{S}_{{2}^{- 1}} ( x , y ) = {α}_{- 1} ( \frac{1}{3} {\sum }_{u = 1}^{3} \frac{{D}_{{2}^{- 1}}^{u} ( x , y )}{Max ( {D}_{{2}^{- 1}}^{u} )} ) \\ {S}_{{2}^{j}} ( x , y ) = \frac{1}{2} ( {α}_{j} ( \frac{1}{3} {\sum }_{u = 1}^{3} \frac{{D}_{{2}^{j}}^{u} ( x , y )}{Max ( {D}_{{2}^{j}}^{u} )} ) + \frac{1}{4} {\sum }_{u = 0}^{1} {\sum }_{v = 0}^{1} {S}_{{2}^{j + 1}} ( 2 x + u , 2 y + v ) )\end{matrix}$$

13. A method according to claim 12, wherein the parameter αₖ is equal to −1/r for all the values of k.

14. A method according to claim 7,wherein said selection step comprises a step for building a tree structure of said salience values.

15. A method according to claim 14, wherein said step for the construction of a tree structure of said salience values relies on a zerotree type of approach.

16. A method according to claim 14, wherein said selection step advantageously comprises the steps of:
descending-order sorting of the salience values of the salience map corresponding to the minimum resolution; and
selection of the branch having the highest salience value for each of the trees thus sorted out.

17. A method according to claim 16, wherein said step for the selection of the branch having the highest salience value implements a corresponding scan of the tree starting from its root and a selection, at each level of the tree, of the offspring node having the highest salience value.

18. A method according to claim 1, wherein said wavelet transformation implements the Haar base.

19. A method according to claim 1, wherein a minimum level of resolution 2⁻⁴.

20. A method according to claim 1, comprising a step for the computation of an image signature from a predetermined number of points of interest of said image.

21. A method according to claim 20, wherein said signature is used especially to index images by their content.

22. Application of the method for detecting points of interest in a source digital image according to claim 1 to at least one of the fields selected from the group consisting of:
image watermarking;
image indexing; and
the detection of faces in an image.

23. A device for the detection of points of interest in a source digital image, implementing a wavelet transformation associating a sub-sampled image, called a scale image, with a source image, and wavelet coefficients corresponding to at least one detail image, for at least one level of decomposition,
a point of interest being a point associated with a region of the image showing high frequencies, wherein the device comprises:
means for the application of said wavelet transformations to said source images during which for each decomposition level, there are determined at least two detail images corresponding respectively to at least two directions predetermined by said wavelet transformation;
means for the merging of the coefficients of said detail images so as not to give preference to any direction of said source image;
means for the construction of a unique tree structure from the wavelet coefficients of each of said detail images; and
means for the selection of at least one point of interest by analysis of said tree structure.

24. A device according to claim 23, wherein the means for the application, means for the merging means for the construction and means for the selection comprise.

25. Computer program product comprising program code instructions recorded on a carrier usable in a computer, comprising computer-readable programming means for the implementation of a wavelet transformation associating a sub-sampled image, called a scale image, with a source image, and wavelet coefficients corresponding to at least one detail image, for at least one level of decomposition,
a point of interest being a point associated with a region of the image showing high frequencies wherein the computer program product comprises:
computer-readable programming means to carry out the application of said wavelet transformation to said source image, during which, for each decomposition level there are determined at least two detail images corresponding respectively to at least two directions predetermined by said wavelet transformation;
computer-readable programming means to carry out the merging of the coefficients of said detail images so as not to give preference to any direction of said source image;
computer-readable programming means to carry out the construction of a unique tree structure from the wavelet coefficients of each of said detail images;
computer-readable programming means to carry out the selection of at least one point of interest by analysis of said tree structure.

26. Computer-usable digital data carrier comprising program code instructions of a computer program according to claim 25.
